(19) United States
(12) Patent Application Publication
(10) Pub. No.: US 2014/0089121 A1
(43) Pub. Date: Mar. 27, 2014

(54) ARRANGEMENT FOR AND METHOD OF ALERTING A USER TO CONTEXT-BASED TRANSACTIONAL INFORMATION UNDER WHICH PRODUCTS ARE TO BE TRANSACTED AT A POINT-OF-TRANSACTION SITE

(71) Applicant: SYMBOL TECHNOLOGIES, INC., Schaumburg, IL (US)

(72) Inventors: Michael A. Kaminsky, Baldwin, NY (US); Esha Bhargava, Astoria, NY (US); Curt D. Croley, Stony Brook, NY (US); Nicholas Matarese, Brooklyn, NY (US)

(73) Assignee: Symbol Technologies, Inc., Schaumburg, IL (US)

(21) Appl. No.: 13/627,410

(22) Filed: Sep. 26, 2012

(51) Int. Cl. G06Q 20/20

(52) U.S. Cl. 705/23

(57) ABSTRACT

A user is alerted to context-based transactional information under which products are to be transacted at a point-of-transaction site by a speaker on an electro-optical reader. The speaker announces, as an audible message, to the user a detailed context under which each product identified to the reader is to be transacted. The audible message is broadcast as a sound wave either corresponding to a pattern of original speech, or to a sound effect. The detailed context can, for example, be a reminder to deactivate an electronic article surveillance (EAS) tag associated with each identified product, or a reminder that the identified product is on sale.

### FIELD OF THE DISCLOSURE

The present disclosure relates generally to an arrangement for, and a method of, alerting a user to context-based transactional information under which products are to be transacted at a point-of-transaction site and, more particularly, to broadcasting the context-based transactional information as audible messages configured as sound waves corresponding to patterns of original speech or sound effects.

### BACKGROUND

Moving laser beam readers or laser scanners have long been used as data capture devices to electro-optically read targets, such as one-dimensional bar code symbols, particularly of the Universal Product Code (UPC) type, printed on labels associated with products in many venues, such as supermarkets, warehouse clubs, department stores, and other kinds of retailers. The moving laser beam reader generally includes a housing, a laser for emitting a laser beam, a focusing lens assembly for focusing the laser beam to form a beam spot having a certain size at a focal plane in a range of working distances relative to the housing, a scan component for repetitively scanning the beam spot across a target in a scan pattern, for example, a scan line or a series of scan lines, across the target multiple times per second, a photodetector for detecting light reflected and/or scattered from the target and for converting the detected light into an analog electrical signal, and signal processing circuitry including a digitizer for digitizing the analog signal and a microprocessor for decoding the digitized signal based upon a specific symbology used for the target. The decoded signal identifies the product and is transmitted to a host, e.g., a cash register in a retail venue, for further processing, e.g., product price look-up or product inventorying.

Solid-state imaging systems or imaging readers have also been used as data capture devices in such venues to electro-optically read such targets, as well as two-dimensional bar code symbols, such as PDF417 and QR codes, either printed on product labels or displayed on a display screen of an electronic device, such as a smart phone. The target may also be a form, such as a document, label, receipt, signature, driver's license, employee badge, or payment/loyalty card, etc., each having data fields bearing alphanumeric characters, as well as a picture, to be imaged. The imaging reader includes a housing, a solid-state imager or sensor having an array of cells or photosensors, which correspond to image elements or pixels in a field of view of the imager, an illuminating light assembly for illuminating the field of view with illumination light from an illumination light source, e.g., one or more light emitting diodes (LEDs), and an imaging lens assembly for capturing return ambient and/or illumination light scattered and/or reflected from the target being imaged over a range of working distances. Such an imager may include a one- or two-dimensional charge coupled device (CCD) or a complementary metal oxide semiconductor (CMOS) device analogous to those conventionally used in consumer digital cameras, and associated circuits for producing electronic signals corresponding to a one- or two-dimensional array of pixel information over the field of view. Signal processing circuitry including a microprocessor processes the electronic signals to decode the target if the target is a symbol. If the target is a form, then the microprocessor processes the electronic signals to identify the form and the data fields thereon. An aiming light generator may also be provided in the housing for projecting an aiming light pattern or mark on the target prior to imaging. If the target is a symbol, then the decoded signal identifies the product and is transmitted to a host, e.g., a cash register in a retail venue, for further processing, e.g., product price look-up or product inventorying.

Both types of readers have been operated in a portable, wireless, handheld mode, in which an operator, e.g., a clerk or a customer, held the respective wireless housing in his or her hand, and aimed the respective wireless housing at the target, and then initiated the data capture and the reading of the target by manual actuation of a trigger on the respective housing. Both types of readers typically included a beeper to provide audio feedback, and/or an indicator light to provide video feedback, of a successful read or an error condition. The beeper is an electroacoustic transducer that converts electrical energy into mechanical energy to emit a single audible beeping tone, or a plurality of the same beeping tones. The indicator light includes a single light emitting diode (LED) for emitting light of one color, or two LEDs for emitting light of different colors.

As advantageous as the audio/video feedback has been, the beeping tones did not always provide clear, unambiguous feedback to the user, especially in a noisy retail venue. One beeping tone could sometimes be mistaken for another. Likewise, the indicator light did not always provide clear, unambiguous feedback, especially in a brightly lit, retail venue.

In an effort to provide clearer audio feedback, the art has suggested incorporating a speaker in the reader to broadcast audible error messages. However, the functionality of the speaker, just like that of the beeper, was limited to reader performance, e.g., was the read successful or not and, if not, what was the cause of the reader error. The art has also suggested using the speaker to announce price information. However, as advantageous as using the speaker has been, its functionality and usage could be enhanced by announcing and/or indicating information, other than reader performance or price information. The retail experience of many clerks and/or customers would be improved if they were alerted to detailed transactional information concerning the product itself.

Accordingly, there is a need to enhance the functionality and usage of audio/video feedback in such readers to improve the retail experience, and to alert the clerk and/or the customer to the circumstances or conditions under which the products are to be transacted, e.g., purchased.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of an arrangement for alerting a user to context-based transactional information under which products are to be transacted at a point-of-transaction site in accordance with the present disclosure.

FIG. 2 is a broken-away schematic view of a laser-based embodiment of an electro-optical reader for use in the arrangement of FIG. 1.

FIG. 3 is a broken-away schematic view of an imager-based embodiment of an electro-optical reader for use in the arrangement of FIG. 1.

FIG. 4 is a flow chart depicting steps performed in accordance with the method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One aspect of this disclosure relates to an arrangement for alerting a user, e.g., a clerk and/or a customer, to context-based transactional information under which products are to be transacted at a point-of-transaction site. The arrangement comprises an electro-optical reader operatively connected to a host, e.g., a cash register, preferably along a bidirectional wireless link. The reader includes a data capture assembly in the reader for capturing data from targets associated with respective products, a microprocessor in the reader for processing the data, a memory accessible to the microprocessor for storing sound information, and a speaker controlled by the microprocessor for producing audible sounds based on the sound information stored in the memory. The host is operative for receiving the data processed by the microprocessor to identify each product, and for sending the context-based transactional information relating to each identified product to the microprocessor to cause the speaker to announce, as an audible message, to the user a detailed context under which each identified product is to be transacted.

Advantageously, the speaker is operative for producing the audible sounds as sound waves corresponding to patterns of original speech or sound effects. The reader preferably includes a light assembly controlled by the microprocessor for displaying light of a distinct color in accompaniment with the audible message announced by the speaker.

In one embodiment, the data capture assembly includes a solid-state imager for capturing an image of each target, in which case, the microprocessor processes the image of each target. In another embodiment, the data capture assembly includes a scan component for moving a laser beam across each target for reflection therefrom, and a detector for detecting return light from each target, in which case, the microprocessor processes the return light from each target.

Advantageously, the host includes an updatable database for storing identities of all the products, and for storing customized context-based transactional information for each product. The context-based transactional information is not information relating to reader performance and is not price information, but, instead, the customized context-based transactional information preferably includes one or more of the following messages: a reminder to deactivate an electronic article surveillance (EAS) tag associated with the identified product, a reminder that the identified product is on sale, a reminder that the identified product is available for a discount, a reminder that the identified product is seasonal, a reminder that the identified product is a high value item, a reminder that the identified product requires special handling, a reminder that the identified product is being sold under time constraints, a reminder that the identified product is being sold under temperature constraints, and a reminder that the identified product is being sold under usage constraints.

A method, in accordance with another aspect of this disclosure, of alerting a user to context-based transactional information under which products are to be transacted at a point-of-transaction site, is performed by capturing data from targets associated with respective products, processing the data, storing sound information, producing audible sounds based on the stored sound information with a speaker, receiving the processed data to identify each product, and sending the context-based transactional information relating to each identified product to the speaker to cause the speaker to announce, as an audible message, to the user a detailed context under which each identified product is to be transacted.

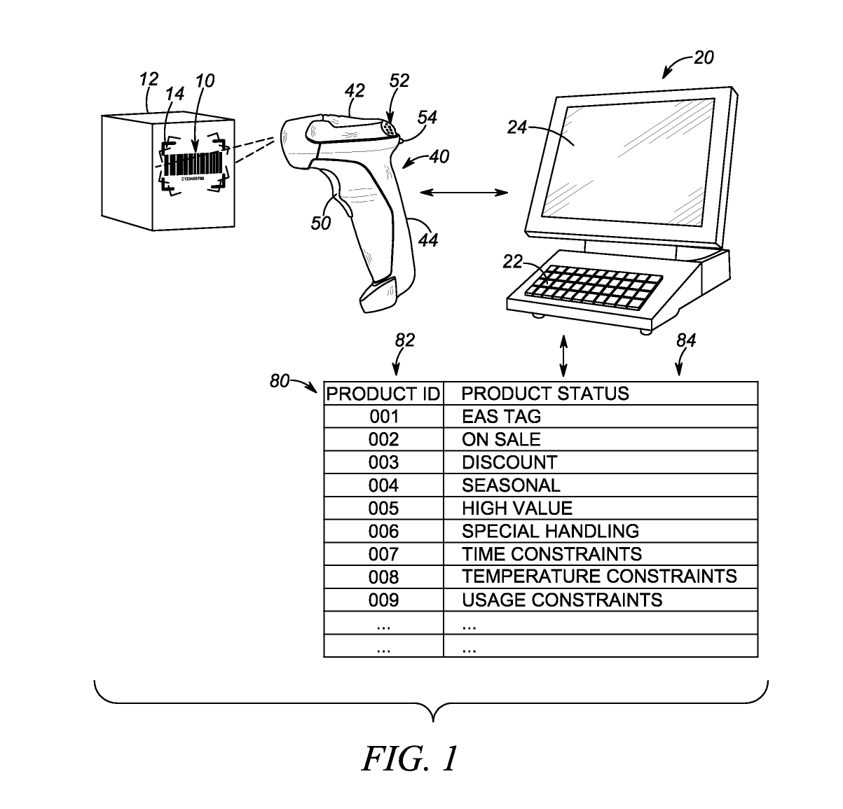

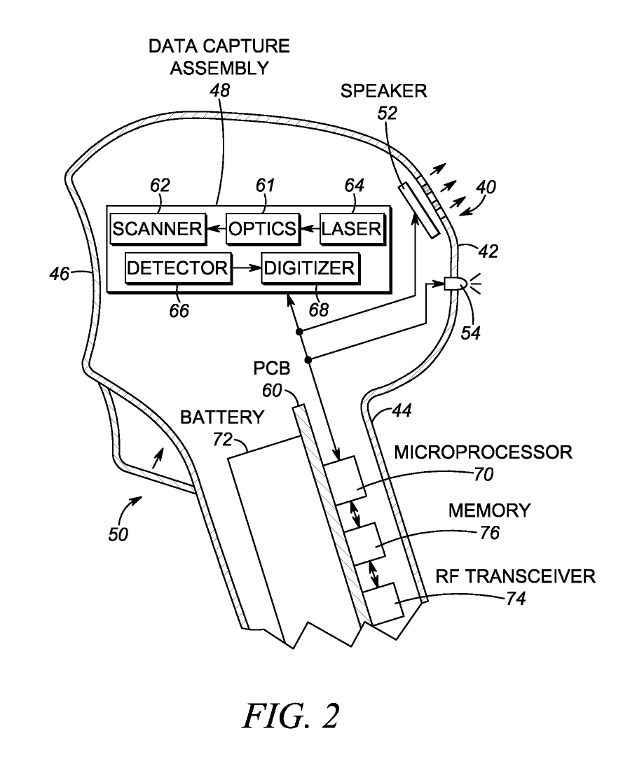

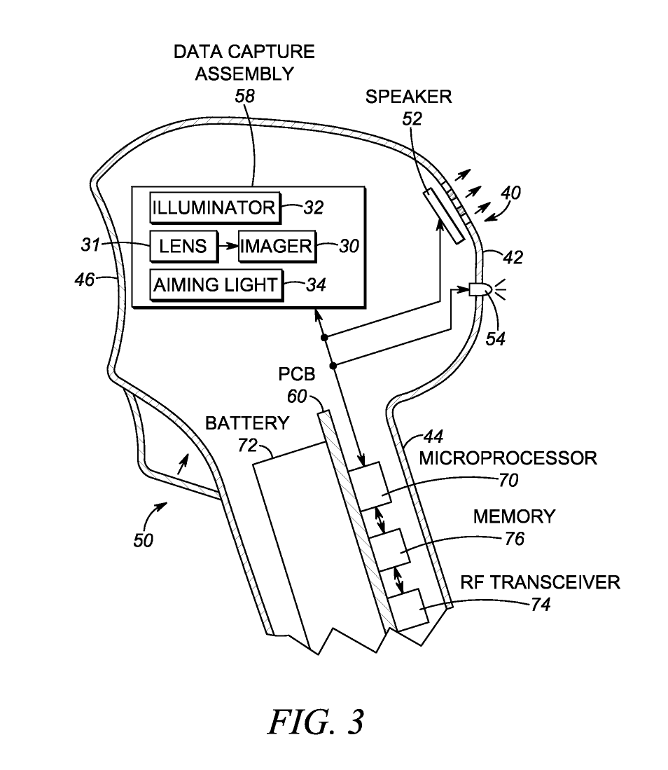

Turning now to the drawings, FIG. 1 depicts an electro-optical, handheld reader 40 for electro-optically reading a target 10, such as a coded symbol, associated with a product 12 to be transacted, e.g., purchased, at a point-of-transaction site at a retail venue, such as a supermarket. Although the product 12 has been illustrated as a box, this was done merely for ease of illustration, because virtually any product 12 can be purchased or processed at the site. As explained below in connection with FIGS. 2-3, the reader 40 is a data capture device that identifies the product 12 by reading the target 10 and, as shown, includes a portable, handheld housing 42 having a handle 44 on which a manually actuatable trigger 50 for initiating reading is mounted. The reader 40 is operatively connected, either over a wired or a wireless link, to a remote host 20, e.g., a cash register, at the retail venue. The remote host 20 may have a keyboard 22 for data entry, and a display 24.

A moving laser beam embodiment of the reader 40, as shown in FIG. 2, includes a scanner 62 mounted in the housing 42 and operative for scanning an outgoing laser beam from a laser 64 and/or a field of view of a light detector or photodiode 66 in a scan pattern, typically comprised of one or more scan lines, multiple times per second, for example, one-hundred times per second, through a housing window 46 across the target 10 for reflection or scattering therefrom as return light detected by the photodiode 66 during reading. The beam reader 40 also includes a focusing lens assembly or optics 61 for optically modifying the outgoing laser beam to have a large depth of field, and a digitizer 68 for converting an electrical analog signal generated by the detector 66 from the return light into a digital signal for subsequent decoding by a microprocessor or controller 70 into data indicative of the target 10 being read to identify the product 12. The aforementioned components, except for the microprocessor 70, is depicted in FIG. 2 as a data capture assembly 48.

An imaging embodiment of the reader 40, as shown in FIG. 3, includes a one- or two-dimensional, solid-state imager 30, preferably a CCD or a CMOS array, mounted in the portable handheld housing 42 and having an array of image sensors operative, together with an imaging lens assembly 31, for capturing return light reflected and/or scattered from the target 10 through the housing window 46 during the imaging to produce an electrical signal indicative of a captured image for subsequent decoding by the microprocessor 70 into data indicative of the target 10 being read to identify the product 12.

The imaging reader of FIG. 3 includes an illuminator 32 for illuminating the target 10 during the imaging with illumination light directed from an illumination light source through the window 46. Thus, the return light may be derived from the illumination light and/or ambient light. The illumination light source comprises one or more light emitting diodes (LEDs). An aiming light assembly 34 may also be provided for emitting an aiming beam and for projecting an aiming light pattern 14 (see FIG. 1) or mark on the target 10 prior to imaging. The aforementioned components, except for the microprocessor 70, is depicted in FIG. 3 as a data capture assembly 58.

In operation of the imaging reader of FIG. 3, the microprocessor 70 sends a command signal to drive the illuminator LEDs 32, typically continuously, or sometimes periodically, during reading, and energizes the imager 30 during an exposure time period of a frame to collect light from the target 10 during a short time period, say 500 microseconds or less. A typical array needs about 11-33 milliseconds to read the entire target image and operates at a frame rate of about 30-90 frames per second. The array may have on the order of one million addressable image sensors.

Also shown in FIGS. 2-3 is a printed circuit board (PCB) 60 in the handle 44 on which the microprocessor 70, a rechargeable battery 72, a radio frequency (RF) transceiver 74, and a memory 76 are mounted. The rechargeable battery 72 is optional and is employed in the wireless mode of operation to supply electrical power to all the electrical components in the readers 40 of FIGS. 2-3. The RF transceiver 74 is preferably a Bluetooth® module that provides bi-directional communication with a corresponding Bluetooth® module in the host 20. This Bluetooth® module in the host 20 receives decoded data processed by the microprocessor 70. Bluetooth® is an open wireless standard for short-range transmission of digital voice and data between devices and supports point-to-point and multipoint applications. The microprocessor 70 accesses and retrieves data from the memory 76, as described below.

In accordance with one aspect of this disclosure, the memory 76 is operative for storing sound information, and a speaker 52 is mounted in the reader 40 and is controlled by the microprocessor 70 for producing audible sounds based on the sound information stored in the memory 76. The host 20 is operative for receiving the decoded data processed by the microprocessor 70 to identify each product 12, and for sending context-based transactional information, as described below, relating to each identified product 12 to the microprocessor 70 to cause the speaker 52 to announce, as an audible message, to the user a detailed context under which each identified product 12 is to be transacted.

As schematically shown in FIG. 1, the host 20 includes, and can access, an updatable database 80 having at least one data field (Product ID) 82 for storing identities of all the products 12, and at least another data field (Product Status) 84 for storing customized context-based transactional information for each product 12. The database 80 can be updated in real time or periodically. The context-based transactional information is not information relating to reader performance and is not price information, but, instead, the customized context-based transactional information preferably includes one or more of the following audible messages: a reminder to deactivate an electronic article surveillance (EAS) tag associated with the identified product, a reminder that the identified product is on sale, a reminder that the identified product is available for a discount, a reminder that the identified product is seasonal, a reminder that the identified product is a high value item, a reminder that the identified product requires special handling, a reminder that the identified product is being sold under time constraints, a reminder that the identified product is being sold under temperature constraints, and a reminder that the identified product is being sold under usage constraints, and so on.

Advantageously, the speaker 52 is operative for producing the audible messages as sound waves corresponding to patterns of original speech or sound effects. The memory 76 stores the audio messages. The microprocessor 70 determines which audible message is to be retrieved based on the identity of the product 12. Different products 12 cause the microprocessor 70 to send different audible messages to the speaker 52 to be broadcast by the speaker 52 to provide the user with audio voice synthesized information regarding the circumstances or conditions under which the product 12 is to be purchased.

By way of non-limiting examples, if the product 12 is identified as having an EAS tag, then the audible message might be: “Please deactivate the EAS tag”. If the product 12 is identified as being on sale, then the audible message might be: “Item on sale”. If the product 12 is identified as being available for a discount, then the audible message might be: “Discounted item”. If the product 12 is identified as being available for a seasonal promotion, then the audible message might be: “Seasonal item”. If the product 12 is identified as being of high value, then the audible message might be: “High value item”. If the product 12 is identified as requiring special handling, then the audible message might be: “Item fragile”. If the product 12 is identified as being sold under time constraints, then the audible message might be: “Use by expiration date”. If the product 12 is identified as being sold under temperature constraints, then the audible message might be: “Refrigerate after opening”. If the product 12 is identified as being sold under usage constraints, then the audible message might be: “Take before bedtime”. Rather than, or in addition to, configuring the audible message as human speech, the audible message could be configured as a sound effect. For example, the sound effect “cha-ching”, which is indicative of the sound that a cash register would make when a cash drawer is closed after money has been placed in the drawer, could be employed to indicate that an item is on sale. Other sound effects are contemplated.

The reader 40 preferably includes a light assembly 54 controlled by the microprocessor 70 for displaying light of a distinct color and/or in a distinct flashing pattern in accompaniment with the audible message announced by the speaker 52.

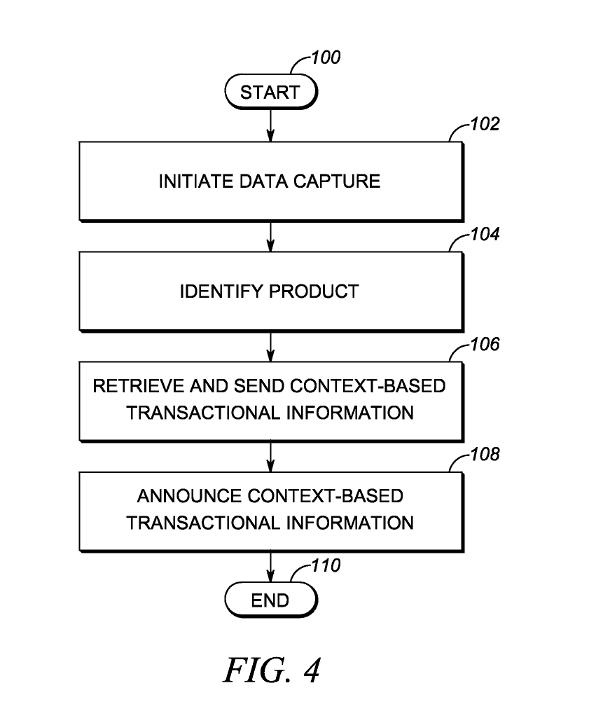

Turning now to the flow chart of FIG. 4, a method of alerting a user to context-based transactional information under which products 12 are to be transacted at a point-of-transaction site, is performed, by starting a reading session in step 100, by capturing data from targets 10 associated with respective products 12 in step 102, by processing the captured data to identify each product 12 in step 104, by retrieving and sending the context-based transactional information relating to each identified product to the speaker 52 in step 106, and by causing the speaker 52 to announce, as an audible message, to the user a detailed context under which each identified product 12 is to be transacted in step 108, prior to ending the reading session in step 110.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for alerting a user to context-based transactional information under which products are to be transacted at a point-of-transaction site, comprising:
an electro-optical reader including a data capture assembly in the reader for capturing data from targets associated with respective products, a microprocessor in the reader for processing the data, a memory accessible to the microprocessor for storing sound information, and a speaker controlled by the microprocessor for producing audible sounds based on the sound information stored in the memory; and
a host operatively connected to the reader for receiving the data processed by the microprocessor to identify each product, and for sending the context-based transactional information relating to each identified product to the microprocessor to cause the speaker to announce, as an audible message, to the user a detailed context under which each identified product is to be transacted.

2. The arrangement of claim 1, wherein the data capture assembly includes a solid-state imager for capturing an image of each target, and wherein the microprocessor is operative for processing the image of each target.

3. The arrangement of claim 1, wherein the data capture assembly includes a scan component for moving a laser beam across each target for reflection therefrom, and a detector for detecting return light from each target, and wherein the microprocessor is operative for processing the return light from each target.

4. The arrangement of claim 1, wherein the host includes an updatable database for storing identities of all the products, and for storing customized context-based transactional information for each product.

5. The arrangement of claim 4, wherein the customized context-based transactional information includes at least one of a reminder to deactivate an electronic article surveillance (EAS) tag associated with the identified product, a reminder that the identified product is on sale, a reminder that the identified product is available for a discount, a reminder that the identified product is seasonal, a reminder that the identified product is a high value item, a reminder that the identified product requires special handling, a reminder that the identified product is being sold under time constraints, a reminder that the identified product is being sold under temperature constraints, and a reminder that the identified product is being sold under usage constraints.

6. The arrangement of claim 1, wherein the reader and the host are operatively connected along a bidirectional wireless link.

7. The arrangement of claim 1, wherein the speaker is operative for producing the audible sounds as sound waves corresponding to patterns of original speech.

8. The arrangement of claim 1, wherein the speaker is operative for producing the audible sounds as sound effects.

9. The arrangement of claim 1, wherein the reader includes a light assembly controlled by the microprocessor for displaying light of a distinct color in accompaniment with the audible message announced by the speaker.

10. A method of alerting a user to context-based transactional information under which products are to be transacted at a point-of-transaction site, comprising:
capturing data from targets associated with respective products;
processing the data;
storing sound information;
producing audible sounds based on the stored sound information with a speaker;
receiving the processed data to identify each product; and
sending the context-based transactional information relating to each identified product to the speaker to cause the speaker to announce, as an audible message, to the user a detailed context under which each identified product is to be transacted.

11. The method of claim 10, wherein the data capturing is performed by capturing an image of each target, and wherein the processing is performed by processing the image of each target.

12. The method of claim 10, wherein the data capturing is performed by moving a laser beam across each target for reflection therefrom, and by detecting return light from each target, and wherein the processing is performed by processing the return light from each target.

13. The method of claim 10, and storing identities of all the products, and storing customized context-based transactional information for each product, in an updatable database.

14. The method of claim 13, and configuring the customized context-based transactional information to include at least one of a reminder to deactivate an electronic article surveillance (EAS) tag associated with the identified product, a reminder that the identified product is on sale, a reminder that the identified product is available for a discount, a reminder that the identified product is seasonal, a reminder that the identified product is a high value item, a reminder that the identified product requires special handling, a reminder that the identified product is being sold under time constraints, a reminder that the identified product is being sold under temperature constraints, and a reminder that the identified product is being sold under usage constraints.

15. The method of claim 10, wherein the receiving and the sending are performed over a bidirectional wireless link.

16. The method of claim 10, wherein the producing of the audible sounds is performed by configuring the audible sounds as sound waves corresponding to patterns of original speech.

17. The method of claim 10, wherein the producing of the audible sounds is performed by configuring the audible sounds as sound effects.

18. The method of claim 10, and displaying light of a distinct color in accompaniment with the audible message announced by the speaker.
